(19) United States
(12) Patent Application Publication
(10) Pub. No.: US 2024/0374935 A1
(43) Pub. Date: Nov. 14, 2024

(54) FACE MASK CUSHION

(71) Applicant: Honeywell Safety Products USA, Inc., Charlotte, NC (US)

(72) Inventors: Tanguy Herve Andre Pierre PREVOT, Brno (CZ); Jakub CHARVAT, Sternberk (CZ); Martin ZBORAN, Jasenica (SK); Petr SNAJDR, Milotice (CZ)

(21) Appl. No.: 18/313,902

(22) Filed: May 8, 2023

(51) Int. Cl. A62B 18/02; A41D 13/11; A62B 23/02

(52) U.S. Cl. CPC A62B 18/02; A41D 13/1161; A41D 13/1184; A62B 23/02

(57) ABSTRACT

Various devices, assemblies, components, systems, and methods are provided relating to a cushion for a face mask assembly. An example cushion may include an annular sealing wall having an annular sealing surface and having an annular internal surface. The annular sealing surface may engage a face of a user. The cushion may further include an annular support wall extending circumferentially along the annular sealing wall. The annular support wall may compress into contact with the annular support wall. The cushion may further include a connector wall extending between a proximal end of the annular sealing wall and a proximal end of the annular support wall.

### TECHNICAL FIELD

The present disclosure relates to a cushion for a face mask assembly. In particular, the cushion may include an annular sealing wall and an annular support wall configured to support the sealing wall. Various devices, assemblies, components and methods are also provided.

### BACKGROUND

Face mask assemblies may be used to protect users' faces and may filter the air inhaled by the user in various situations. Face mask assemblies may use a seal that presses against a user's skin; however, these seals may create pressure points due to a lack of uniform pressure and/or may fail to properly seal the face mask assembly. Through applied effort, ingenuity, and innovation, Applicant has solved problems relating to a cushion for a face mask assembly by developing solutions embodied in the present disclosure, which are described in detail below.

### BRIEF SUMMARY

Various embodiments of the present disclosure include cushions, assemblies, face mask assemblies, and corresponding systems, devices, components, and methods related to a face mask cushion.

Various embodiments of the present disclosure may include a cushion for a face mask. The cushion may include an annular sealing wall having an annular sealing surface. The annular sealing surface may be configured to engage a face of a user. The annular sealing wall may further include an annular internal surface opposite the annular sealing surface. The cushion may further include an annular support wall extending along the annular sealing wall. The annular sealing wall may be configured to contact the annular internal surface in an instance in which the annular sealing wall is compressed into contact with the annular support wall. The cushion may further comprise a connector wall extending between a proximal end of the annular sealing wall and a proximal end of the annular support wall.

In some embodiments, the annular sealing wall and the annular support wall may be configured to define at least one acute angle therebetween. In some embodiments, a length of the annular sealing wall measured between the proximal end of the annular sealing wall and a distal end of the annular sealing wall may be greater than a length of the annular support wall measured between the proximal end of the annular support wall and a distal end of the annular support wall. In some embodiments, the cushion may define an annular gap between the annular sealing wall and the annular support wall in an instance in which the face of the user is not compressing the annular sealing wall. In some embodiments, the annular gap and the annular support wall may be configured to define a progressive cushioning behavior of the cushion. In an example embodiment, a first resilient force of the cushion may be upon initial contact of the face of the user with the annular sealing wall and may be less than a second resilient force of the cushion after the annular scaling wall is compressed into contact with the annular support wall.

In some embodiments, the cushion may further comprise an end member. The end member may be connected to the connector wall on an opposite side of the annular support wall from the annular sealing wall. In some embodiments, the end member may be connected to the connector wall at a reflex angle such that the end member extends at least partially in an opposite direction of the annular sealing wall and the annular support wall for a given cross-section of the cushion. In some embodiments, compression of the cushion may be configured to cause a connection between the end member and connector wall to flex and increase the reflex angle. In some embodiments, the end member may further comprise a face shield sealing wall configured to contact a face shield.

Various embodiments of the present disclosure may include a face mask assembly. The face mask assembly may include a cushion. The cushion may include an annular sealing wall having an annular sealing surface. The annular sealing surface may be configured to engage a face of a user. The annular sealing wall may further include an annular internal surface opposite the annular sealing surface. The cushion may further include an annular support wall extending along the annular sealing wall. The annular sealing wall may be configured to contact the annular internal surface in an instance in which the annular sealing wall is compressed into contact with the annular support wall. The cushion may further comprise a connector wall extending between a proximal end of the annular sealing wall and a proximal end of the annular support wall. The face mask assembly may further comprise a transparent face shield configured to engage with the cushion.

The face mask assembly may further comprise a breathing portion configured to cover a mouth and/or a nose. The cushion may be configured to at least partially surround the breathing portion along the face of the user. The face mask assembly may further comprise at least one strap configured to secure the face mask assembly to the user. The face mask may be configured to scal an internal volume between the face of the user and the face mask assembly.

In some embodiments, the annular scaling wall and the annular support wall may be configured to define at least one acute angle therebetween. In some embodiments, a length of the annular scaling wall measured between the proximal end of the annular scaling wall and a distal end of the annular sealing wall may be greater than a length of the annular support wall measured between the proximal end of the annular support wall and a distal end of the annular support wall. In some embodiments, the cushion may define an annular gap between the annular sealing wall and the annular support wall in an instance in which the face of the user is not compressing the annular scaling wall. In some embodiments, the annular gap and the annular support wall may be configured to define a progressive cushioning behavior of the cushion. In an example embodiment, a first resilient force of the cushion may be upon initial contact of the face of the user with the annular sealing wall and may be less than a second resilient force of the cushion after the annular sealing wall is compressed into contact with the annular support wall.

In some embodiments, the cushion may further comprise an end member. The end member may be connected to the connector wall on an opposite side of the annular support wall from the annular sealing wall. In some embodiments, the end member may be connected to the connector wall at a reflex angle such that the end member extends at least partially in an opposite direction of the annular sealing wall and the annular support wall for a given cross-section of the cushion. In some embodiments, compression of the cushion may be configured to cause a connection between the end member and connector wall to flex and increase the reflex angle. In some embodiments, the end member may further comprise a face shield sealing wall configured to contact a face shield. In some embodiments, the face mask assembly may further comprise a respirator assembly. A breathing portion of the respirator assembly may comprise at least one filter element configured to filter air entering the face mask assembly.

Various embodiments may include a method of using a face mask assembly. The method may include holding the face mask assembly to a user face. The face mask assembly may comprise a cushion. The cushion may comprise an annular scaling wall having an annular sealing surface. The annular sealing surface may be configured to engage a face of a user. The annular sealing wall may further include an annular internal surface opposite the annular sealing surface. The cushion may further include an annular support wall extending along the annular sealing wall. The annular scaling wall may be configured to contact the annular internal surface in an instance in which the annular scaling wall is compressed into contact with the annular support wall. The cushion may further comprise a connector wall extending between a proximal end of the annular scaling wall and a proximal end of the annular support wall. The face mask assembly may further comprise a transparent face shield configured to engage the cushion. The face mask assembly may further include a breathing portion configured to cover a mouth and/or a nose, wherein the cushion is configured to at least partially surround the breathing portion along the face of the user. The face mask assembly may further comprise at least one strap configured to secure the face mask assembly to the user. The face mask assembly may be configured to seal an internal volume between the face of the user and the face mask assembly. The method may further include securing the at least one strap about the user's head. The method may further include compressing the cushion to form a seal between the annular sealing layer and the face of the user.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses may potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a side perspective view of an example face mask assembly in accordance with various embodiments of the present disclosure;

FIG. 2 illustrates a top perspective view of an example face mask assembly in accordance with various embodiments of the present disclosure;

FIG. 3 illustrates a side cross-sectional view of an example face mask assembly in accordance with various embodiments of the present disclosure;

FIG. 4 illustrates a side cross-sectional view of an example face mask assembly on a user face in accordance with various embodiments of the present disclosure;

FIG. 5A illustrates a cross-sectional perspective view of an example cushion in accordance with various embodiments of the present disclosure;

FIG. 5B illustrates a cross-sectional perspective view of an example cushion in accordance with various embodiments of the present disclosure;

FIG. 6 illustrates a front perspective view of an example cushion in accordance with various embodiments of the present disclosure;

FIG. 7A illustrates a cross-sectional view of a top portion of an example cushion in accordance with various embodiments of the present disclosure;

FIG. 7B illustrates a cross-sectional view of a top portion of an example cushion with a first force in accordance with various embodiments of the present disclosure;

FIG. 7C illustrates a cross-sectional view of a top portion of an example cushion with a second force in accordance with various embodiments of the present disclosure;

FIG. 7D illustrates a cross-sectional view of a bottom portion of an example cushion in accordance with various embodiments of the present disclosure;

FIG. 7E illustrates a cross-sectional view of a bottom portion of an example cushion with a first force in accordance with various embodiments of the present disclosure; and

FIG. 7B illustrates a cross-sectional view of a bottom portion of an example cushion with a second force in accordance with various embodiments of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout.

As used herein, terms of direction such as “front,” “rear,” “top,” etc. are used for explanatory purposes in the examples provided below to describe the relative positions of certain components or portions of components to other components or portions of components described in the particular context indicated and should not be interpreted to require an absolute position relative to other points of reference (e.g., relative to the Earth). As used herein, the term “or” is used in both the alternative and conjunctive sense, unless otherwise indicated. The term “along,” and similarly utilized terms, means near or on, but not necessarily requiring direct contact with a surface or other referenced location. The terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present disclosure.

As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Face mask assemblies and other apparatuses meant to be tightly secured to a delicate surface, such as the human body, may experience tradeoffs between attachment quality and damage or discomfort cause to the underlying surface. For example, some respirator assemblies may include face mask assemblies and may filter and/or supplement the air breathed by a wearer. Some respirator assemblies may be worn tightly to prevent inadvertent leakage or air intrusion from unintended pathways (e.g., around the perimeter of the respirator). However, tightening the respirator onto a user's face may cause additional harm or discomfort to the user. Some traditional respirator seals may not provide effective seals while maintaining user comfort. For example, transverse ribs supporting a seal may create pressure points against a user's skin.

As described herein, the present disclosure includes a cushion for a face mask assembly, including but not limited to face mask assemblies used in respirator assemblies, configured to improve the comfort of a user. The cushion may further be configured to maintain a strong seal against the user's face, which may reduce the risk of the customer. For example, in some embodiments, the cushion may define a progressive cushioning behavior whereby the resilient force of the cushion increases with compression, which may allow the seal to closely contour to a user's face. In some embodiments, the cushion may include a substantially consistent sealing profile and resilient behavior around the circumference of the cushion to avoid pressure points (e.g., each location includes the same type of progressive resilience rather than having spaced ribs or other more rigid structures in discrete locations around the cushion). Moreover, the cushioning behavior may vary depending upon the degree of deflection caused by the user's face at each location of the cushion, to provide smoothly-transitioned increases in force where the user's face deflects the cushion the most, which may minimize hard points at which the cushion bottoms out against the face shield structure or other rigid structures of the face mask assembly.

For example, the depicted cushion may include an annular sealing wall, an annular support wall, and a connector wall therebetween. In some embodiments, the annular sealing wall that may define an annular sealing surface. The annular scaling surface is be configured to engage a face of a user, and the annular support wall may be disposed adjacent to and extending circumferentially along the annular sealing wall. The annular support wall may contact an internal surface of the annular sealing wall in an instance the annular sealing wall is at least partially compressed into contact with the annular support wall or further contact with the annular support wall. In some embodiments, the annular sealing wall and the annular support wall may define an annular gap therebetween.

In various embodiments, the annular gap and the annular support wall may define a varied cushioning behavior over the compression of the cushion. The annular gap may become smaller upon the application of a first force to the cushion. In some embodiments, the annular scaling wall may contact the annular support wall upon the application of a sufficient force to close the annular gap, which may increase the resilient force of the cushion against further deformation.

In various embodiments, the cushion may further comprise an end member that connects to the connector wall on an opposite side of the annular support wall from the annular scaling wall. The end member may connect at a reflex angle such that the end member to flex and increase the reflex angle.

The cushion may be a part of a face mask assembly that may create an airtight seal between the user's face and the cushion. In some embodiments, the face mask assembly may further include at least one strap and a breathing portion. The at least one strap may assist in securing the face mask assembly to the user, and the breathing portion may comprises at least one filter element configured to filter air entering the face mask to define a respirator assembly.

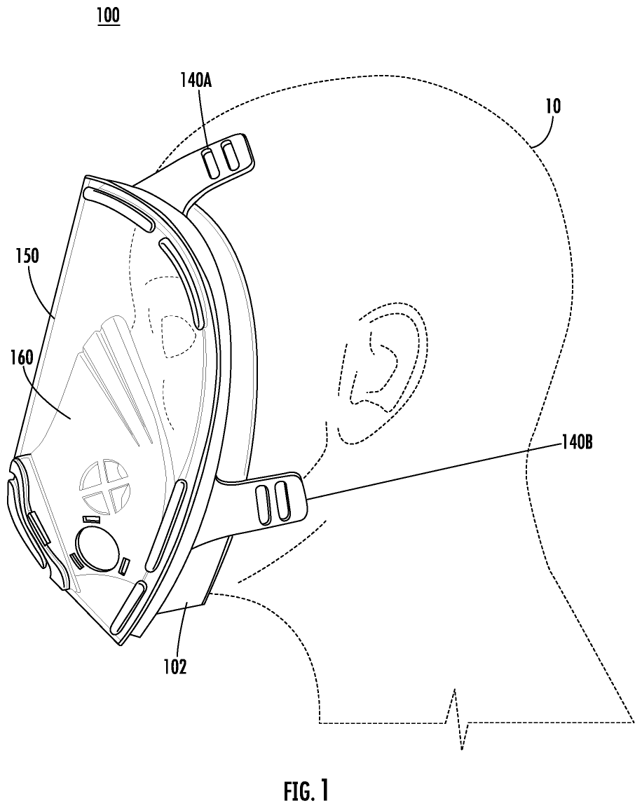

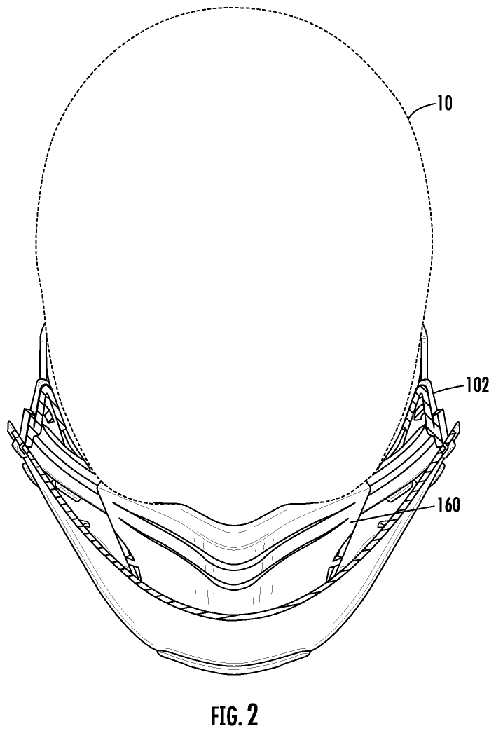

FIGS. 1-7F depict exemplary views of an example cushion, face mask assembly, and respirator assembly and portions thereof in accordance with various embodiments of the present disclosure. FIGS. 1 and 2 respectively depict a side view and a top cross-sectional view of a face mask assembly 100 attached to the head of a user 10. In the depicted embodiment, the face mask assembly 100 may comprise a cushion 102, a face shield 150, and a breathing portion 160 that define a respirator assembly with a filter element and/or air supply for providing clean breathable air to a user. In some embodiments, the cushion may be used with other face mask assemblies, such as a snorkeling or scuba diving face mask assembly.

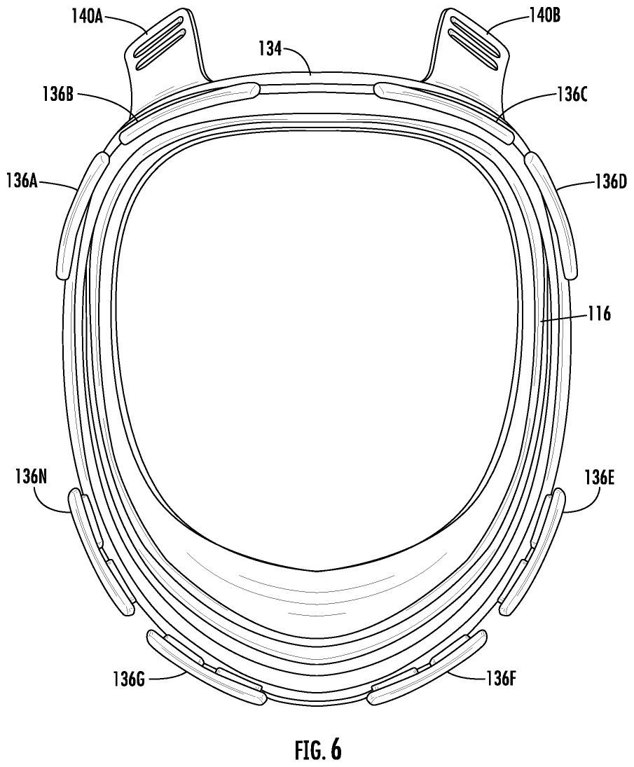

In the depicted embodiments, the face mask assembly 100 is a frameless assembly in which the cushion 102 may secure directly to the face shield 150. The contact between the cushion and each of the user's head and the face shield 150 creates an airtight seal from the external environment. The face shield 150 may comprise a plurality of openings, and the cushion 102 may comprise a plurality of protrusions (e.g., protrusions 136C-F shown in FIG. 1 and protrusions 136A-F shown in FIG. 6) configured to engage with the openings of the face shield. For example, in the depicted embodiment, the openings are slot-shaped and narrower in cross-sectional area than the heads of the protrusions. The protrusions may be configured to secure the face shield 150 against the cushion 102 to prevent air leaks therebetween.

In various embodiments, the cushion 102 may further define at least one strap 140A, 140B (collectively “140”) configured to secure the face shield 150 to the user 10. The depicted straps 140 are shown on a bottom portion of a user's head and on an upper portion of a user's head. The face mask assembly 100 may be configured to define an internal volume between the interior of the face mask assembly components and the user's face in an instance in which the face mask assembly is secured to the user 10. In some embodiments, the breathing portion 160 may be at least partially connected to the face shield 150 and/or cushion 102. The breathing portion 160 may be configured to engage the user's nose and mouth to facilitate breathing with the face mask assembly. In the depicted embodiment, the breathing portion 160 surrounds the user's nose and mouth and extends from the user's face to the face shield 150, and the face shield 150 comprises an opening through which a distal end of the breathing portion extends to allow the user to breathe. The breathing portion 160 may further comprise at least one filter (e.g., filter 162 shown in FIG. 3) configured to filter toxins entering the face mask assembly 100.

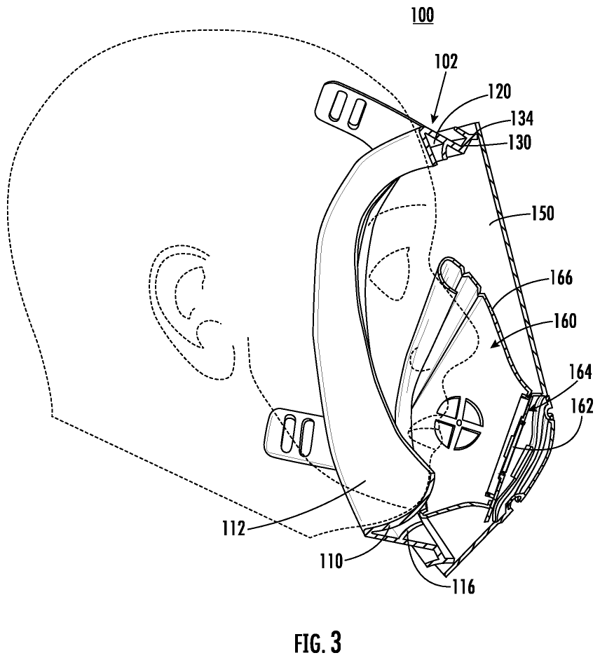

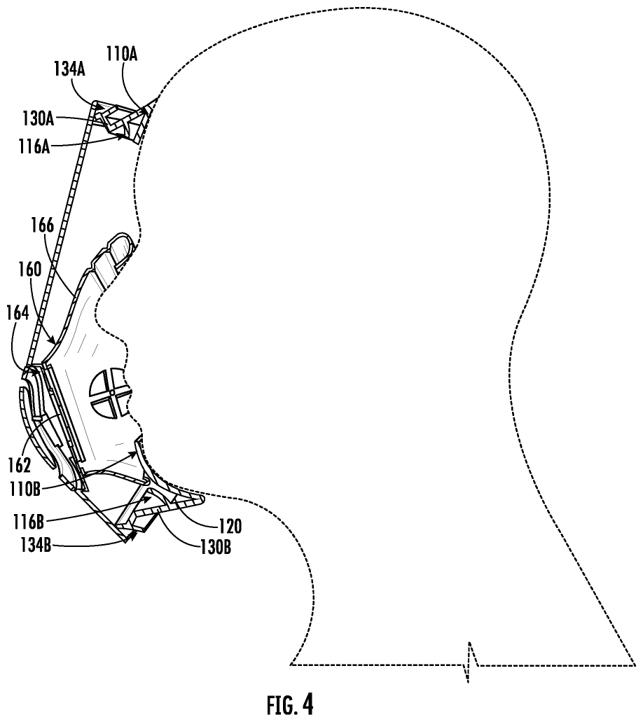

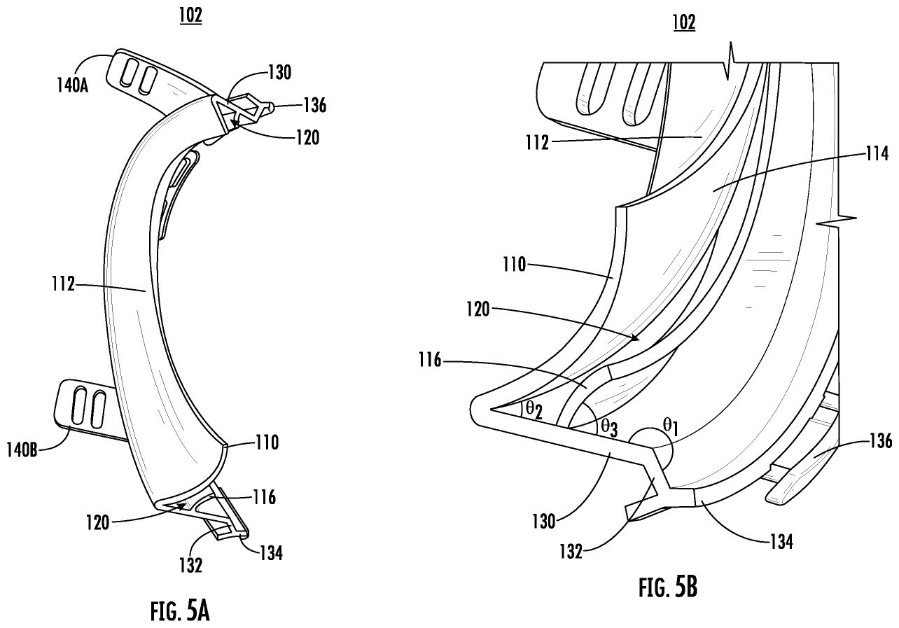

FIGS. 3-4 depict side cross-sectional views and perspective cross-sectional views of the face mask assembly 100 in accordance with various embodiments of the present disclosure. Further, FIGS. 5A-5B include isolated, cross-sectional views of example embodiments of the cushion 102 of the face mask assembly. In various embodiments, the cushion 102 may comprise an annular scaling wall 110, an annular support wall 116, and a connector wall 130 extending between proximal ends of the annular sealing wall and annular support wall. The components of the cushion 102 may form a sealing structure that also provides comfort to a user without pressure points when wearing the face mask assembly 100. In various embodiments, a length of the annular sealing wall 110, when measuring between a proximal end of the annular sealing wall (e.g., the end connected to the connector wall 130) and a distal end of the annular sealing wall (e.g., the free end), may be greater than the length of the annular support wall 116, when measuring between a proximal end of the annular support wall and a distal end of the annular support wall. The annular scaling wall 110 may further define an annular sealing surface 112 and an annular internal surface 114. The annular sealing surface 112 may face outwardly relative to the face shield 150, such that the annular sealing surface 112 may at least partially contact a face of the user. The annular scaling surface 112 may be further configured to at least partially create an airtight seal between the face of the user and the cushion 102. The annular internal surface 114 of the annular sealing wall 110 is configured to be disposed opposite to the annular sealing surface 112. The annular internal surface may at least partially contact the annular support wall under the various circumstances described herein in which the annular sealing wall and annular support wall contact each other.

In various embodiments, the annular scaling wall 110 and the annular support wall 116 are configured to define at least partially an annular gap 120 therebetween during at least some circumstances in which the annular scaling wall is not compressed into the annular support wall. The annular internal surface 114 of the annular sealing wall 110 and an annular internal surface of the annular support wall 116 may define at least a portion of the annular gap 120. In various embodiments, the annular gap 120 comprises a greater volume in an instance in which the face of the user is not compressing against the annular scaling wall 110 (e.g., no pressure added to the annular sealing wall). The annular gap 120 and/or the annular support wall 116 may be configured to define the progressive cushioning behavior of the cushion 102. In some instances, the annular support wall 116 may not contact or may lightly contact the annular internal surface 114 of the annular scaling wall 110 along at least a portion of the circumference of the cushion 102 in an instance in which no force is applied to the annular sealing wall 110. In some embodiments, the annular support wall 116 may at least partially contact the annular internal surface 114 of the annular scaling wall 110 in an instance in which no force is applied to the annular sealing wall 110 along at least a portion of the circumference of the cushion 102. The annular support wall 116 may contact and/or may increase the surface area in contact with the annular internal surface 114 of the annular sealing wall 110 in an instance in which a first force (e.g., cushion initial contact with face of the user) is applied to the annular sealing wall 110. The increased surface area of the annular support wall 116 in contact with the annular internal surface 114 of the annular scaling wall 110 may be configured to decrease the volume of the annular gap 120 defined therebetween. In some embodiments, one or more additional force may be applied to the cushion 102 further decreasing the volume of the annular gap 120 and in some instances increasing the surface area of contact between the annular support wall 116 may at least partially contact the annular internal surface 114 of the annular scaling wall 110.

In some embodiments, the forces applied to the cushion may be unequal in different location depending upon the shape of the user's face relative to the cushion 102. In such embodiments, the cushion 102 may have a varied reaction force about its circumference depending upon the degree of force applied by the user's face. In some embodiments, the annular scaling wall 110 and/or the annular support wall 116 may comprise individual thicknesses from 0.9 mm to 3 mm. In some embodiments, the annular sealing wall 110 and/or the annular support wall 116 may comprise individual thicknesses from 0.9 mm to 2 mm. In some embodiments, the annular scaling wall 116 and/or the annular support wall 116 may preferably comprise thicknesses from 0.9 mm to 1.3 mm. In some embodiments, the annular sealing wall 110 and/or the annular support wall 116 may comprise individual thicknesses of 1 mm. In some embodiments, the annular scaling wall 110 and the annular support wall 116 may comprise different thicknesses according to any of the dimensions and ranges discussed herein. In some embodiments, the annular scaling wall 110 may be thinner than the annular support wall 116. In some embodiments, the annular scaling wall 110 and the annular support wall 116 may have the same thickness. In some embodiments, the annular scaling wall 110 and/or the annular support wall 116 may vary in thickness about their respective circumferences. For example, the annular sealing wall 110 and/or the annular support wall 116 may be configured to tailor the pressure around the face based on the local thickness of soft tissue (e.g., chin and forehead receiving less pressure than cheeks). The progressive cushion behavior may be defined by the interaction between the user's face, the annular sealing wall 110, and the annular support wall 116 for each given circumferential position about the cushion 102. For example, the annular scaling wall 110 itself may yield relatively easily to the compression of the user's face, creating a soft and contour-fitting seal and the annular support wall 116 may supply additional resistive force as the annular sealing wall 110 is deflected into the annular support wall 116 by the user's face. The annular support wall 116 thereby causes a stronger net force from the cushion 102 in circumferential locations having the highest compression. Pressure points are simultaneously avoided by the annular sealing wall 110 and the annular support wall 116 extending along each other about the circumference of the cushion. The structure of the cushion may further allow locations that are circumferentially adjacent to the larger compressive forces of the user's face (e.g., adjacent local or absolute force maxima) to also be deflected into further compression due in part to the resilient material of the cushion (e.g., rubber, silicone, etc.) and/or the at least partially uniform structure of the cushion, which may prevent gaps from opening and improve both the seal and comfort of the facemask. In some optional embodiments, the annular scaling wall 110 and/or the annular support wall 116 may define one or more gaps in their circumference. For example, a half-mask implementation of the cushion may be used. In some instances, the half-mask may have an interruption in the annular support wall 116 at the nose bridge of the half mask.

With further reference to FIGS. 3-5B, in various embodiments, the annular support wall 116 may extend circumferentially along the annular sealing wall 110 about the cushion 102. Both the annular scaling wall 110 and the annular support wall 116 may connect to and/or extend from the connector wall 130. The connector wall 130 may extend between a proximal end of the annular scaling wall 110 to at least a proximal end of the annular support wall 116. The connector wall 130, annular scaling wall 110, and/or annular support wall 116 may each be part of the same contiguous piece of cushion material (e.g., as would be extruded or molded simultaneously in some instances), or any one or more of the connector wall 130, annular scaling wall 110, and/or annular support wall 116 may be separately formed and attached to the remaining portions of the cushion.

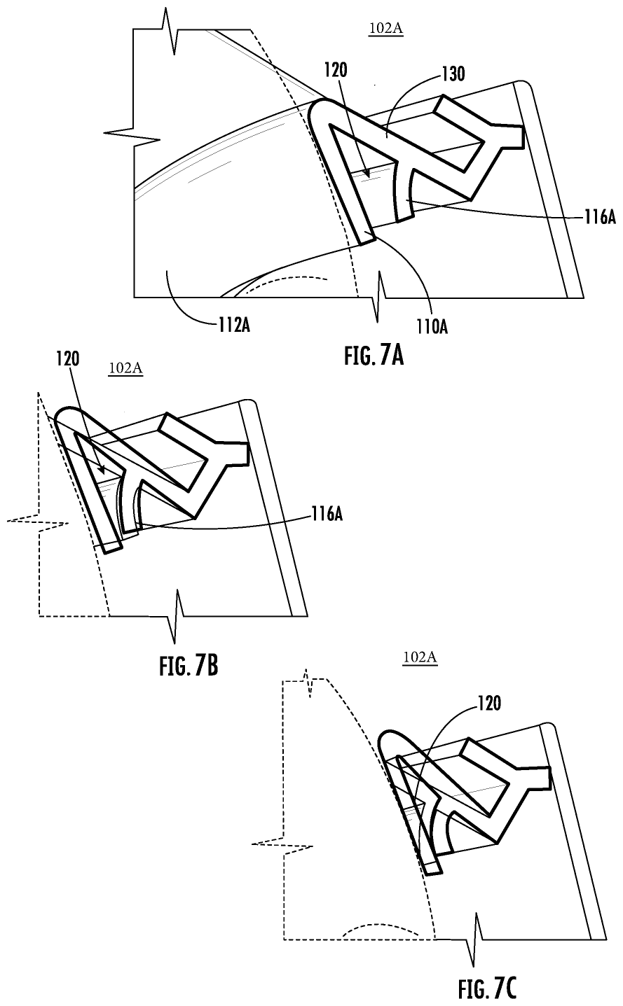

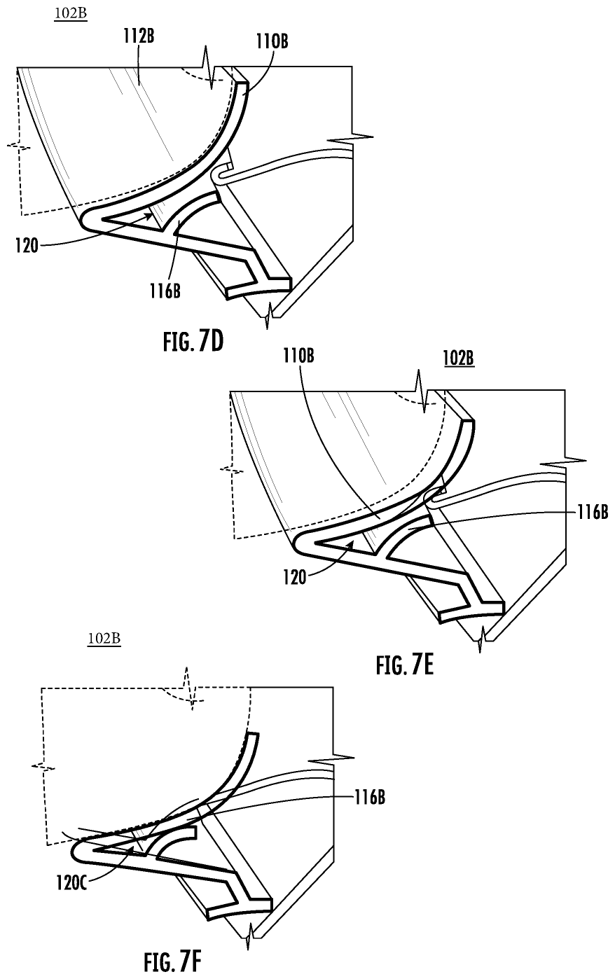

In some embodiments, the connector wall 130 may connect to an end member 132, which may be part of the same contiguous piece of material or separately formed and attached. The depicted end member 132 is connected to the connector wall 130 on an opposite side of the annular support wall 116 than the annular scaling wall 110. In some embodiments, the end member 132 may be connected to the connector wall 130 at a reflex angle (e.g., angle θ1 shown in FIG. 5B). In some embodiments, the angle θ1 between the connector wall 130 and the adjacent section of the end member is greater than 180 degrees and less than 270 degrees. The end member 132 may extend at least partially in an opposite direction from the annular sealing wall 110 and/or the annular support wall 116 (e.g., greater than 180 degrees at the angle θ1 with the angles θ2, 03 of the annular sealing wall 110 and the annular support wall 116 being less than 180 degrees (e.g., less than 90 degrees). In various embodiment, compression applied to the cushion 102 may cause the reflex angle created by the end member 132 and the connector wall 130 to increase thereby using the joint of the end member 132 and the connector wall 130 as an additional force absorbing mechanism that may also be uniformly arranged about the circumference and may create an “accordion” effect that improves the sealing and comfort of the cushion (e.g., as shown in the sequential images of FIGS. 7A-7C and 7D-7F). In various embodiments, the end member 132 may further comprise a face shield sealing wall 134. The face shield sealing wall 134 may comprise a plurality of protrusions 136 configured to assist in engaging and supporting the face shield 150 and/or a frame for the face shield. In some embodiments, the plurality of protrusions 136 may be secured to a corresponding opening defined by the face shield 150.

In various embodiments, the cushion 102 may comprise a material comprising a rubber or silicone material (e.g., silicone, thermoplastic elastomers, etc.) configured to be durable, flexible, and create an airtight seal with the face of the user. In various embodiments, the material may comprise a hardness (on the Shore A hardness scale) between 35 to 60. In some embodiments, the material may further comprise a higher nervosity (e.g., the speed at which a material comes back to its nominal shape/dimension, when released after having been submitted to a deformation). In various embodiments, the cushion 102 comprises a material with a high nervosity such that the cushion 102 is configured to return to its nominal shape upon release of pressure. In various embodiments, the at least one strap 140 of the face mask assembly 100 may be configured to be made up of the same material as the cushion. For example, at least a portion of the at least one strap 140 may be formed as part of the same piece of contiguous material as a remainder of the cushion. For example, in the depicted embodiment, the straps 140 extend rearwards from a rearwardly extending wall of the end member 132 opposite the face shield sealing wall 134. In various embodiments, the face shield 150 may comprise a transparent plastic material or other known material allowing the user to easily see through the shield during use.

With reference to FIGS. 3-4, the breathing portion 160 may engage an opening 164 of the face shield 150 to allow the user to breathe therethrough. The breathing portion 160 may define a soft, flexible cup 166 configured to surround the user's nose and/or mouth to allow breathing without fogging the face shield 150 and without compromising the seal of the face mask assembly 100. The breathing portion 160 may further comprise at least one filter in an instance in which the face mask assembly defines a respirator assembly, wherein the respirator assembly prevents toxins, toxicants, and other harmful substances from entering the face mask assembly or the user's respiratory system.

With continued reference to FIGS. 3-4, in various embodiments, at least a portion of the cushion 102 is configured to overlap with and/or extend into the breathing portion 160. In the depicted embodiment, a lower portion of the annular sealing wall 110B may at least partially contact the chin of the user, while an upper portion of the annular sealing wall may at least partially contact the forehead of the user. In the depicted embodiment, the lower portion of the annular sealing wall 110 extends between the user's face and the lower end of the breathing portion 160 with the breathing portion engaging the annular internal surface 114 of the annular sealing wall. For example, in an instance in which a first force is applied to the cushion 102, the upper portion of the annular support wall 116A may reduce the volume of the upper portion of the annular gap 120 independently from the lower portion of the annular support wall 116B reducing the volume of the lower portion of the annular gap 120. In various embodiments, the variable adjustment of portions of the annular gap 120 in response to different forces may allow the user to form the cushion specifically to the face of that user, wherein this creates a better seal and/or increases the comfort for the user. As further depicted in the embodiments of FIGS. 3-4, the length of the annular scaling wall 110 and/or annular support wall 116 may vary about the circumference of the cushion 102. For example, in the depicted embodiment, the length of the annular sealing wall 110 at the lower end of the cushion is greater than the length of the annular sealing wall at the upper end of the cushion.

With reference to FIGS. 5A-5B, perspective cross-sectional views depict an example cushion 102 in accordance with various embodiments of the present disclosure. In the depicted embodiment of FIGS. 5A-5B, the cushion 102 defines the annular sealing wall 110, the annular support wall 116, and the connector wall 130. In various embodiments, the annular internal surface 114 of the annular sealing wall 110 may define a first acute angle θ2 relative to the connector wall 130. The first acute angle θ2 may be at a maximum in an instance in which the annular scaling wall is yet to contact the face of the user. In an instance in which the first force is applied to the annular sealing surface 112 of the annular sealing wall, the first acute angle θ2 may be configured to decrease as some or more surface area of the annular support wall 116 contacts the annular internal surface 114. In various embodiments, the first acute angle θ2 may be at a minimum in an instance in which a second force is applied to the annular sealing wall 110 fully compressing the cushion, wherein the second force is greater than the first force. In some embodiments, the annular support wall 116 may define a second acute angle θ3 relative to the connector wall 130. The second acute angle θ3 may comprise the same functionality as the first acute angle whereby the angle θ3 is at a maximum when the cushion 102 is uncompressed and decreases as more force is applied to the cushion and the annular sealing wall 110 deflects the annular support wall 116.

With reference to FIG. 6, a front perspective view of an example cushion 102 is depicted in accordance with various embodiments of the present disclosure illustrating a consistent and uniform cushioning structure. In various embodiments, the face shield sealing wall 134 is disposed opposite to the annular sealing surface about the circumference of the cushion, such that the face shield sealing wall 134 at least partially contacts the face shield of the face mask assembly to provide a seal between the cushion and the face shield 150 as part of the sealing structures that separate the internal cavity of the face mask assembly from the exterior environment. In various embodiments, the face shield sealing wall 134 may define a plurality of protrusions 136A-136N (collectively “136”) that extend outwardly from the cushion relative to the face shield sealing wall 134. In the depicted embodiment, a first set of four protrusions 136A, 136B, 136C, 136D are shown on an upper portion of the cushion 102 and a second set of four protrusions 136E, 136F, 136G, 136N are shown on a lower portion of the cushion. The plurality of protrusions may at least partially contact corresponding opening located on the face shield. The protrusions 136 may be inserted into the openings of the face shield 150 to at least partially secure the face shield to the cushion 102. In some embodiments, the protrusions 136, once secured with the corresponding openings of the face shield 150, may help create an airtight seal between the cushion and the face shield.

With further reference to FIG. 6, in various embodiments, the cushion may define at least two straps 140A. 140B (collectively “140”) configured to secure the face mask assembly to the face of the user. In the depicted embodiment, the two visible straps 140A, 140B are shown on opposite sides of the upper portion of the cushion. The straps 140 may be at least a portion of a set of adjustable straps, whereby the user can tighten and/or loosen the straps to better conform to the head shape of the user and ensure a tight seal of the face mask assembly. In some embodiments, the cushion may further define at least one additional strap (shown in FIG. 3) on the lower portion of the cushion 102. The additional strap may comprise the same structure and function of the straps depicted in FIG. 6. In other embodiments, the additional strap may extend/protrude from a first side (e.g., left side) of the lower portion of the cushion, wherein the additional strap may wrap around the neck and/or head of the user and connect on a second side (e.g., right side) of the lower portion of the cushion.

With reference to FIGS. 7A-7C, cross-section views of the upper portion of the cushion 102A are depicted in accordance with various embodiments of the present disclosure depicting sequential positions of the cushion in response to no force, little force, and high force form the user's forehead. In various embodiments, the upper portion of the cushion 102A may be defined as the portion of the cushion configured to contact the portion of the user head above the nose of the user. In the depicted embodiment in FIG. 7A, the annular sealing surface 112A of the annular scaling wall 110A has yet to contact the face of the user. The annular support wall 116A of FIG. 7A in a start position, such that the annular support wall 116A is not contacting the annular scaling wall 110A. In various embodiments, the annular gap 120 may define its largest volume in such an instance. In the depicted embodiment in FIG. 7B, the first force (e.g., initial contact with the face of the user) is applied to the upper portion of the cushion 102A. In the depicted embodiment, the annular support wall 116A may at least partially contact the annular scaling wall 110A shrinking the annular gap 120 to a second volume size. In the depicted embodiment in FIG. 7C, the second, greater force is applied to the upper portion of the cushion 102A. In the depicted embodiment, the annular support wall 116A may reach the maximum surface area to contact the annular scaling wall 110A shrinking the annular gap 120 to a third volume size. The third volume size may be the smallest volume size for the annular gap 120 of the three.

With reference to FIGS. 7D-7F, cross-section views of the lower portion of the cushion 102B are depicted in accordance with various embodiments of the present disclosure, which may compress in a similar manner to the upper portion of the cushion described above. In various embodiments, the lower portion of the cushion 102B may be defined as the portion of the cushion configured to contact the portion of the user head below the nose of the user (e.g., chin). In the depicted embodiment in FIG. 7D, the annular sealing surface 112B of the annular scaling wall 110B has yet to contact the face of the user. The annular support wall 116B may be in a start position, such that the annular support wall 116B is not contacting the annular sealing wall 110B or in some embodiments lightly contacting the annular sealing wall 110B. In various embodiments, the annular gap 120 may define its largest volume in such instance. In the depicted embodiment in FIG. 7D, the first force (e.g., initial contact with the face of the user) is applied to the lower portion of the cushion 102B. In the depicted embodiment, the annular support wall 116B may at least partially contact the annular sealing wall 110B shrinking the annular gap 120 to a second volume size. In the depicted embodiment in FIG. 7F, the second force is applied to the lower portion of the cushion 102B. In the depicted embodiment, the annular support wall 116B may reach the maximum surface area to contact the annular sealing wall 110B of the three shrinking the annular gap 120 to a third volume size. The third volume size may be the smallest volume size of the three for the annular gap 120.

Many modifications and other embodiments of the present disclosure set forth herein will come to mind to one skilled in the art to which this disclosure pertains having the benefit of the teachings presented in the foregoing description and the associated drawings. Therefore, it is to be understood that the present disclosure is not to be limited to specific embodiments disclosed and that modifications and other embodiments are intended to be included within the scope of the appended claims. Moreover, although the foregoing description and the associated drawings describe example embodiments in the context of certain example combination of elements and/or functions, it should be appreciated, in light of the present disclosure, that different combinations of elements and/or functions than those explicitly described above are also contemplated as can be set forth in some of the appended claims. Although specific terms are employed herein, they are used in a generic and descriptive sense only and not for purpose of limitation.

1. A cushion for a face mask, the cushion comprising:
an annular sealing wall having an annular sealing surface configured to engage a face of a user and an annular internal surface opposite the annular sealing surface;
an annular support wall extending circumferentially along the annular sealing wall, the annular support wall being configured to contact the annular internal surface in an instance in which the annular sealing wall is compressed into contact with the annular support wall; and
a connector wall extending between a proximal end of the annular sealing wall and a proximal end of the annular support wall.

2. The cushion of claim 1, wherein the annular sealing wall and the annular support wall are configured to define an acute angle therebetween.

3. The cushion of claim 1, wherein a length of the annular sealing wall measured between the proximal end of the annular sealing wall and a distal end of the annular sealing wall is greater than a length of the annular support wall measured between the proximal end of the annular support wall and a distal end of the annular support wall.

4. The cushion of claim 1, wherein the cushion defines an annular gap between the annular sealing wall and the annular support wall in an instance in which the face of the user is not compressing the annular sealing wall.

5. The cushion of claim 4, wherein the annular gap and the annular support wall are configured to define a progressive cushioning behavior of the cushion whereby a first resilient force of the cushion upon initial contact of the face of the user with the annular sealing wall is less than a second resilient force of the cushion after the annular sealing wall is compressed into contact with the annular support wall.

6. The cushion of claim 1, further comprises an end member connected to the connector wall on an opposite side of the annular support wall from the annular sealing wall.

7. The cushion of claim 6, wherein the end member is connected to the connector wall at a reflex angle such that the end member extends at least partially in an opposite direction of the annular sealing wall and the annular support wall for a given cross-section of the cushion.

8. The cushion of claim 7, wherein compression of the cushion is configured to cause a connection between the end member and connector wall to flex and increase the reflex angle.

9. The cushion of claim 8, wherein the end member further comprises a face shield sealing wall configured to contact a face shield.

10. A face mask assembly, the face mask assembly comprising:
a cushion comprising:
an annular sealing wall having an annular sealing surface configured to engage a face of a user and an annular internal surface opposite the annular sealing surface;
an annular support wall extending circumferentially along the annular sealing wall, the annular support wall being configured to contact the annular internal surface in an instance in which the annular sealing wall is compressed into contact with the annular support wall;
a connector wall extending between a proximal end of the annular sealing wall and a proximal end of the annular support wall;
a transparent face shield configured to engage the cushion;
a breathing portion configured to cover a mouth and/or a nose, wherein the cushion is configured to at least partially surround the breathing portion along the face of the user; and
at least one strap configured to secure the face mask assembly to the user,
wherein the face mask assembly is configured to seal an internal volume between the face of the user and the face mask assembly.

11. The face mask assembly of claim 10, wherein the annular sealing wall and the annular support wall are configured to define an acute angle therebetween.

12. The face mask assembly of claim 10, wherein a length of the annular sealing wall measured between the proximal end of the annular sealing wall and a distal end of the annular sealing wall is greater than a length of the annular support wall measured between the proximal end of the annular support wall and a distal end of the annular support wall.

13. The face mask assembly of claim 10, wherein the cushion defines an annular gap between the annular sealing wall and the annular support wall in an instance in which the face of the user is not compressing the annular sealing wall.

14. The face mask assembly of claim 13, wherein the annular gap and the annular support wall are configured to define a progressive cushioning behavior of the cushion whereby a first resilient force of the cushion upon initial contact of the face of the user with the annular sealing wall is less than a second resilient force of the cushion after the annular sealing wall is compressed into contact with the annular support wall.

15. The face mask assembly of claim 10, further comprises an end member connected to the connector wall on an opposite side of the annular support wall from the annular sealing wall.

16. The face mask assembly of claim 15, wherein the end member is connected to the connector wall at a reflex angle such that the end member extends at least partially in an opposite direction of the annular sealing wall and the annular support wall for a given cross-section of the cushion, and wherein, compression of the cushion is configured to cause a connection between the end member and connector wall to flex and increase the reflex angle.

17. The face mask assembly of claim 16, wherein the end member further comprises a face shield sealing wall configured to contact a face shield.

18. The face mask assembly of claim 10, wherein the transparent face shield comprises a plurality of openings, and wherein the cushion comprises a plurality of protrusions configured to engage the plurality of openings to support the face shield.

19. A respirator assembly comprising the face mask assembly of claim 10, wherein the breathing portion comprises at least one filter element configured to filter air entering the face mask assembly.

20. A method of using the face mask assembly, the method comprising:
holding the face mask assembly to a user face, the face mask assembly comprising:
a cushion comprising:
an annular sealing wall having an annular sealing surface configured to engage a face of a user and an annular internal surface opposite the annular sealing surface;
an annular support wall extending circumferentially along the annular sealing wall, the annular support wall being configured to contact the annular internal surface in an instance in which the annular sealing wall is compressed into contact with the annular support wall;
a connector wall extending between a proximal end of the annular sealing wall and a proximal end of the annular support wall;
a transparent face shield configured to engage the cushion;
a breathing portion configured to cover a mouth and/or a nose, wherein the cushion is configured to at least partially surround the breathing portion along the face of the user;
at least one strap configured to secure the face mask assembly to the user,
wherein the face mask assembly is configured to seal an internal volume between the face of the user and the face mask assembly;
securing the at least one strap about the user's head; and
compressing the cushion to form a seal between the annular sealing wall and the face of the user.
